(19) United States
(12) Patent Application Publication
(10) Pub. No.: US 2018/0239704 A1
(43) Pub. Date: Aug. 23, 2018

(54) TRANSMITTING AND RECEIVING SYSTEM AND INFORMATION PROCESSING APPARATUS

(71) Applicant: FUJI XEROX CO., LTD., Tokyo (JP)

(72) Inventors: Daizo TOMINAGA, Kanagawa (JP); Masahiko MIZUMURA, Kanagawa (JP); Masaki YAJIMA, Kanagawa (JP); Takahisa KOGA, Kanagawa (JP); Yusuke MORITA, Kanagawa (JP); Kazuyuki HIRATA, Kanagawa (JP); Kenta KOIZUMI, Kanagawa (JP); Shuntaro HONJO, Kanagawa (JP); Junki MIZUKAMI, Kanagawa (JP)

(73) Assignee: FUJI XEROX CO., LTD., Tokyo (JP)

(21) Appl. No.: 15/793,687

(22) Filed: Oct. 25, 2017

(30) Foreign Application Priority Data
Feb. 21, 2017 (JP) 2017-030423

(51) Int. Cl. G06F 12/0842; H04L 29/08; G06F 12/0891

(52) U.S. Cl. CPC G06F 12/0842; G06F 2212/154; G06F 12/0891; H04L 67/10

(57) ABSTRACT

A transmitting and receiving system includes a first information processing apparatus and a second information processing apparatus. The first information processing apparatus includes a first cache memory, and the second information processing apparatus includes a second cache memory. The second information processing apparatus is configured to transmit and receive information to and from the first information processing apparatus. When transmission information to be transmitted from the first information processing apparatus to the second information processing apparatus is stored in the first cache memory of the first information processing apparatus, the first information processing apparatus transmits partial information that is included in the stored transmission information to the second information processing apparatus or transmits identification information that identifies the transmission information to the second information processing apparatus.

### CROSS-REFERENCE TO RELATED APPLICATIONS

This application is based on and claims priority under 35 USC 119 from Japanese Patent Application No. 2017-030423 filed Feb. 21, 2017.

### BACKGROUND

### Technical Field

The present invention relates to a transmitting and receiving system and an information processing apparatus.

### SUMMARY

According to an aspect of the invention, there is provided a transmitting and receiving system including a first information processing apparatus and a second information processing apparatus. The first information processing apparatus includes a first cache memory, and the second information processing apparatus includes a second cache memory. The second information processing apparatus is configured to transmit and receive information to and from the first information processing apparatus. When transmission information to be transmitted from the first information processing apparatus to the second information processing apparatus is stored in the first cache memory of the first information processing apparatus, the first information processing apparatus transmits partial information that is included in the stored transmission information to the second information processing apparatus or transmits identification information that identifies the transmission information to the second information processing apparatus.

### BRIEF DESCRIPTION OF THE DRAWINGS

Exemplary embodiments of the present invention will be described in detail based on the following figures, wherein:

FIG. 1 illustrates an image forming apparatus according to an exemplary embodiment, which includes a transmitting and receiving system;

FIGS. 2A and 2B illustrate a specific example of processing;

FIGS. 3A and 3B illustrate a specific example of the processing;

FIG. 4 illustrates a specific example of the processing;

FIGS. 5A and 5B illustrate a specific example of the processing;

FIGS. 6A and 6B illustrate processing according to a comparative example;

FIG. 7 illustrates the processing according to the comparative example;

FIG. 8 illustrates another example configuration of the transmitting and receiving system; and

FIG. 9 illustrates still another example configuration of the transmitting and receiving system.

### DETAILED DESCRIPTION

An exemplary embodiment of the present invention will be described in detail hereinafter with reference to the accompanying drawings.

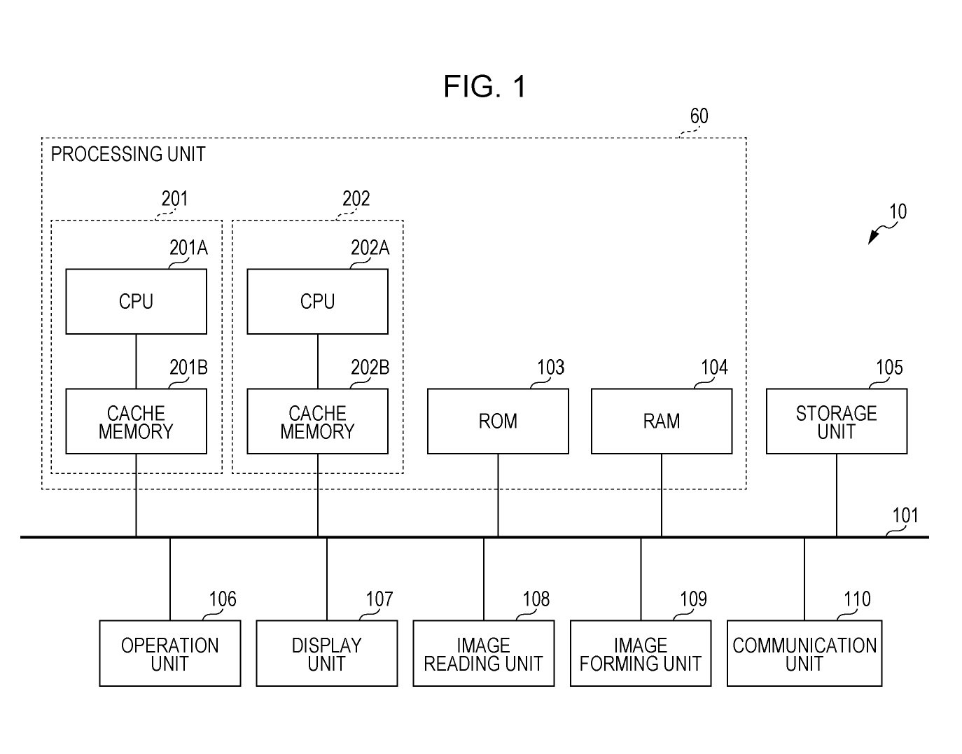

FIG. 1 illustrates an image forming apparatus 10 according to this exemplary embodiment.

As illustrated in FIG. 1, functional units in the image forming apparatus 10 according to this exemplary embodiment are connected to a bus 101 and exchange data via the bus 101.

An operation unit 106 receives a user operation. The operation unit 106 includes hardware keys, for example. Alternatively, the operation unit 106 includes, for example, a touch panel on which a control signal corresponding to a pressed position is output.

A display unit 107 includes a liquid crystal display, for example, and displays data concerning the image forming apparatus 10. Further, the display unit 107 displays a menu screen to which the user refers to operate the image forming apparatus 10.

An image reading unit 108 includes a scanner device and reads an image on a document set thereon to generate a read image (image data).

An image forming unit 109 forms a toner image on a sheet based on image data by using, for example, an electrophotographic system. The image forming unit 109 may form an image by using any other system such as an inkjet head system.

A communication unit 110 serves as a communication interface that is connected to a communication line (not illustrated) to communicate with other devices connected to the communication line.

A storage unit 105 includes a storage device such as a hard disk drive and stores, for example, data received by the communication unit 110 or image data obtained by the image reading unit 108 or the like.

A processing unit 60 controls each unit of the image forming apparatus 10 or performs processing (image processing) on image data obtained by the image reading unit 108 or the like.

The processing unit 60 includes a first information processing unit 201 and a second information processing unit 202. The first information processing unit 201 is an example of a first information processing apparatus, and the second information processing unit 202 is an example of a second information processing apparatus.

The first information processing unit 201 includes a central processing unit (CPU) 201A and a cache memory 201B. In the first information processing unit 201, the CPU 201A executes a predetermined program to implement a function of transmitting information (an information transmitting unit) and a function of receiving information (an information receiving unit) to transmit and receive information to and from any other functional unit such as the second information processing unit 202.

Also, the second information processing unit 202 includes a CPU 202A and a cache memory 202B. In the second information processing unit 202, as in the first information processing unit 201, the CPU 202A executes a predetermined program to implement a function of transmitting information (an information transmitting unit) and a function of receiving information (an information receiving unit).

A cache memory is a memory used to compensate for a difference in performance between a CPU and a storage device such as a random access memory (RAM), that is, a memory acting as a buffer for the difference in speed between a CPU and a RAM or the like, and includes a static random access memory (SRAM), for example.

In this exemplary embodiment, information is transmitted and received between the first information processing unit 201 and the second information processing unit 202. Thus, a portion including the first information processing unit 201 and the second information processing unit 202 may be regarded as a transmitting and receiving system in which information is transmitted and received.

The processing unit 60 further includes a read only memory (ROM) 103 that stores programs to be executed by the CPU 201A in the first information processing unit 201 and by the CPU 202A in the second information processing unit 202. The processing unit 60 further includes a RAM 104.

The CPU 201A in the first information processing unit 201 reads a program stored in the ROM 103 and executes the program using the RAM 104 and the cache memory 201B as work areas.

The CPU 202A in the second information processing unit 202 also reads a program stored in the ROM 103 and executes the program using the RAM 104 and the cache memory 202B as work areas.

When the CPU 201A and the CPU 202A execute the programs, for example, processing (image processing) is performed on image data. When the CPU 201A and the CPU 202A execute the programs, for example, an image is formed on a sheet. When the CPU 201A and the CPU 202A execute the programs, for example, an image on a document is read and a read image (image data) of the document is generated.

The programs to be executed by the CPU 201A and the CPU 202A may be stored in a computer-readable recording medium and provided to the image forming apparatus 10. Examples of the computer-readable recording medium include a magnetic recording medium (such as a magnetic tape or a magnetic disk), an optical recording medium (such as an optical disk), a magneto-optical recording medium, and a semiconductor memory.

Alternatively, the programs to be executed by the CPU 201A and the CPU 202A may be downloaded to the image forming apparatus 10 by using a communication medium such as the Internet.

In this exemplary embodiment, software is run (i.e., programs are executed) on two CPUs, namely, the CPU 201A and the CPU 202A.

In a case where two CPUs, namely, the CPU 201A and the CPU 202A, are used, the same (or common) memory area may be inaccessible from the two CPUs, namely, the CPU 201A and the CPU 202A, so that it may be difficult to share data between the CPU 201A and the CPU 202A.

In this case, the CPUs 201A and 202A are required to transmit and receive data stored in the cache memories 201B and 202B to and from each other, which results in an increase in the amount of communication between the CPUs 201A and 202A. The increase in the amount of communication may cause a process delay, leading to a reduction in productivity during processing, such as delay in printing on sheets.

In the configuration according to this exemplary embodiment, in contrast, as described below, the amount of communication between the CPUs 201A and 202A is reduced, which prevents or reduces the occurrence of delay in processing.

In this exemplary embodiment, two information processing units, namely, the first information processing unit 201 and the second information processing unit 202, perform information transmission and reception processes using the same algorithm to reduce the amount of communication between the CPU 201A and the CPU 202A.

Specifically, in this exemplary embodiment, each of the first information processing unit 201 and the second information processing unit 202 sets a short command for a frequently used command (a frequently transmitted and received command) and transmits and receives the short command. The transmission and reception of the short command may require a smaller amount of communication than the transmission and reception of the command itself.

In this exemplary embodiment, as described above, the same algorithm is used to transmit and receive information. Thus, short commands set by the first information processing unit 201 and the second information processing unit 202 are identical.

More specifically, in this exemplary embodiment, when information is to be transmitted, one of the information processing units 201 and 202 which serves as a transmitter-side information processing unit transmits a short command to the other, receiver-side information processing unit if the short command has been registered in the cache memory of the transmitter-side information processing unit.

Upon receipt of the short command, the receiver-side information processing unit refers to the cache memory thereof and obtains the command corresponding to the received short command from the cache memory. The command corresponding to the short command is an example of associated information.

In this exemplary embodiment, as described above, the first information processing unit 201 and the second information processing unit 202 respectively store information in the cache memory 201B and the cache memory 202B in accordance with the same algorithm.

This may ensure that the identity between information stored in the cache memory 201B of the first information processing unit 201 and the cache memory 202B of the second information processing unit 202 is maintained (coherency between the cache memories 201B and 202B is maintained) with the reduced amount of communication between the first information processing unit 201 and the second information processing unit 202.

Specifically, in this exemplary embodiment, a command is transmitted and received between the first information processing unit 201 and the second information processing unit 202. When the command is to be transmitted and received, the command is cached if the command is a frequent command. In addition, a short command is set for the command. Then, one of the first information processing unit 201 and the second information processing unit 202 transmits the short command to the other information processing unit.

In this exemplary embodiment, furthermore, when transmitting a command to a receiver-side information processing unit, a transmitter-side information processing unit checks the cache memory thereof and determines whether a short command corresponding to the command has already been registered. If the short command has already been registered, the transmitter-side information processing unit transmits the short command to the receiver-side information processing unit.

Upon receipt of the short command from the transmitter-side information processing unit, the receiver-side information processing unit checks the cache memory thereof and determines whether the received short command has been registered. If the short command has been registered, the receiver-side information processing unit obtains the original command associated with the short command (the original command corresponding to the short command) and executes the original command.

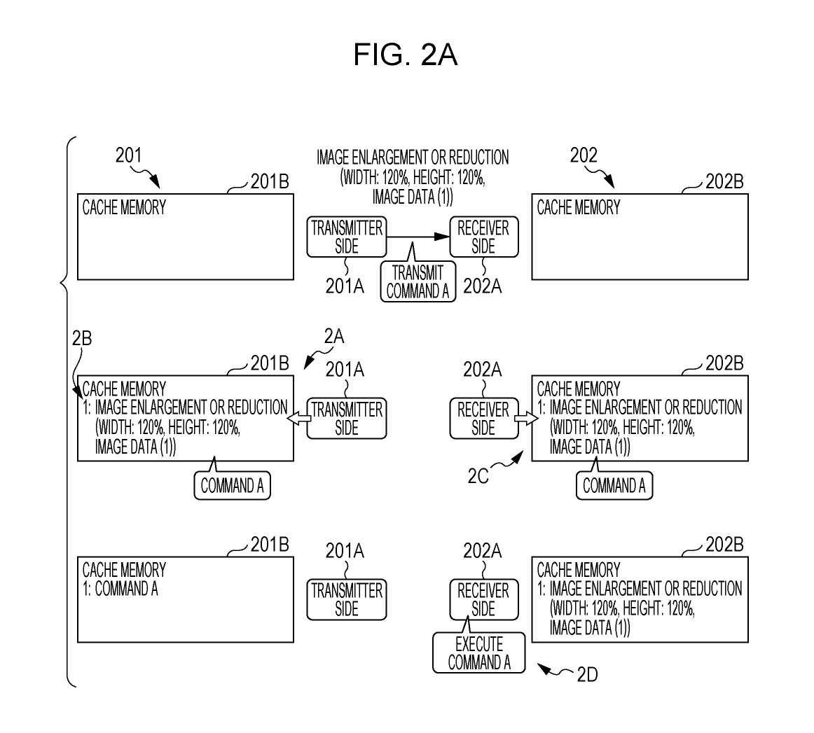

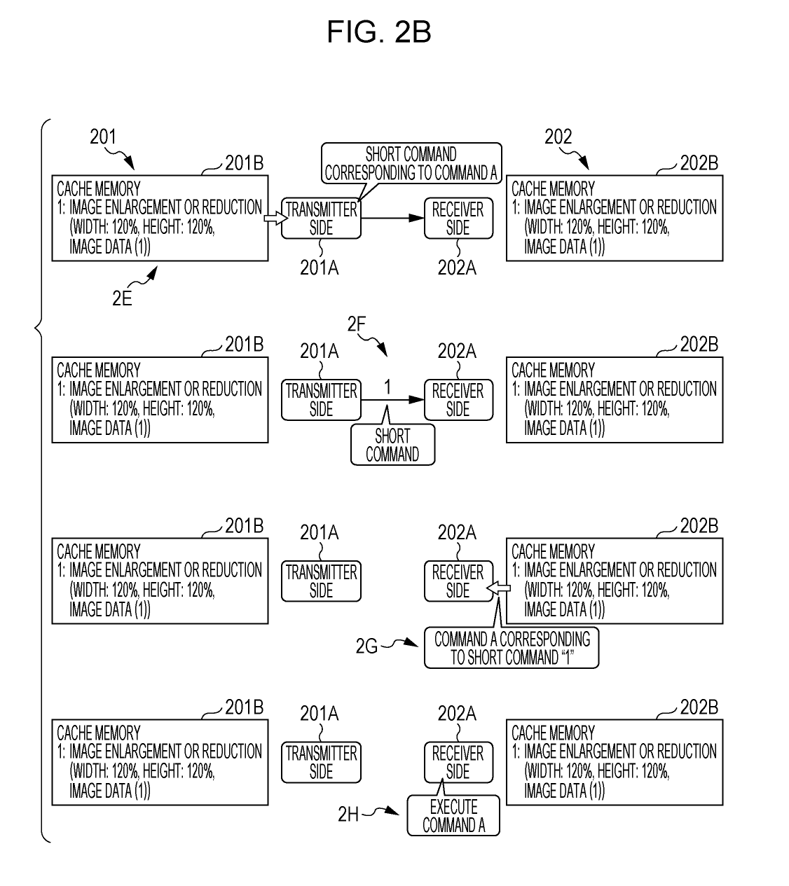

FIGS. 2A, 2B, 3A, 3B, 4, 5A, and 5B illustrate a specific example of processing.

FIG. 2A illustrates a process for sending a command A (an example of transmission information) from the first information processing unit 201 to the second information processing unit 202 multiple times and storing the command A in the cache memory 201B of the first information processing unit 201 and the cache memory 202B of the second information processing unit 202.

The command A is an instruction for enlarging or reducing an image. More specifically, the command A is an instruction for enlarging an image corresponding to image data (1) to 120% in width and to 120% in height.

In this exemplary embodiment, the command A is expressed as: “image enlargement or reduction (width: 120%, height: 120%, image data (1))”. Commands B to F are represented as follows.

Command B=image enlargement or reduction (width: 120%, height: 100%, image data (2))

Command C=image enlargement or reduction (width: 60%, height: 90%, image data (2))

Command D=image rotation (90°, image data (1)) Command E=image binarization (binarization algorithm: type (1), binarization parameter, image data (3))

Command F=image binarization (binarization algorithm: type (2), binarization parameter, image data (3))

A further detailed description is provided. In the process illustrated in FIG. 2A, the first information processing unit 201 acts as a transmitter of information, and the command A is transmitted from the first information processing unit 201 to the second information processing unit 202.

Although not described above, the first information processing unit 201 stores in the storage unit 105 a command transmitted to the second information processing unit 202 and the number of transmissions of the command to the second information processing unit 202. The second information processing unit 202 stores in the storage unit 105 a command received from the first information processing unit 201 and the number of receptions of the command from the first information processing unit 201.

When the first information processing unit 201 is to transmit a command to the second information processing unit 202, the first information processing unit 201 refers to the storage unit 105 and understands the number of transmissions of the command to be transmitted. The second information processing unit 202 refers to the storage unit 105 and understands the number of receptions of a received command.

In this exemplary embodiment, when the number of transmissions of a command from the first information processing unit 201 to the second information processing unit 202 is greater than a predetermined number (when a command is frequently transmitted from the first information processing unit 201 to the second information processing unit 202), the command is stored in the cache memory 201B of the first information processing unit 201.

In other words, when a command is not stored in the cache memory 201B of the first information processing unit 201 and the number of transmissions of the command to the second information processing unit 202 is greater than a predetermined number, the command is stored in the cache memory 201B of the first information processing unit 201.

In the example illustrated in FIG. 2A, the number transmissions of the command A is greater than a predetermined number. In this case, as indicated by numeral 2A, the command A is stored in the cache memory 201B of the first information processing unit 201.

In this exemplary embodiment, at this time, a short command corresponding to the command A is also stored (registered) in the cache memory 201B. In the illustrated example, specifically, as indicated by numeral 2B, short command “1” is stored in the cache memory 201B.

A short command associated with a command is information that uniquely determines the command. In other words, a short command is information capable of identifying each command.

In this exemplary embodiment, as described above, the first information processing unit 201 and the second information processing unit 202 perform information transmission and reception processes using the same algorithm.

Thus, in this exemplary embodiment, when the second information processing unit 202 receives the command A more than a predetermined number of times (frequently receives the command A), as indicated by numeral 2C, the command A is also stored in the cache memory 202B of the second information processing unit 202. In addition, the short command “1” is further stored in the cache memory 202B.

Specifically, when the first information processing unit 201 transmits the command A to the second information processing unit 202 more than a predetermined number of time, the second information processing unit 202 receives the command A more than the predetermined number of times.

In this case, the second information processing unit 202 stores the command A in the cache memory 202B of the second information processing unit 202 and associates the short command “1” with the command A. Accordingly, the command A and the short command “1” are also stored in the cache memory 202B of the second information processing unit 202.

It is to be noted that, in this exemplary embodiment, the storage process for the transmitter-side cache memory and the storage process for the receiver-side cache memory are performed using the same algorithm. When the number of transmissions of information from the first information processing unit 201 and the number of receptions of the information at the second information processing unit 202 are greater than a predetermined number, both the first information processing unit 201 and the second information processing unit 202 respectively store the information (command) in the cache memory 201B and the cache memory 202B and set a short command for the information (command).

In the example process, thereafter, as indicated by numeral 2D in FIG. 2A, the second information processing unit 202 executes the command A.

In the example process, then, the command A is retransmitted from the first information processing unit 201 to the second information processing unit 202.

In this example process, when the command A is to be retransmitted, as indicated by numeral 2E in FIG. 2B, the command A and the short command “1” have already been stored in the cache memory 201B of the first information processing unit 201.

In this case, as indicated by numeral 2F, the short command “1”, rather than the command A, is transmitted from the first information processing unit 201 to the second information processing unit 202. In other words, information capable of identifying the command A is transmitted.

When the second information processing unit 202 serving as the receiver-side information processing unit receives the short command “1”, as indicated by numeral 2G, the CPU 202A of the second information processing unit 202 obtains the original command (associated information) corresponding to the short command “1” from the cache memory 202B of the second information processing unit 202.

It is to be noted that, upon receipt of the short command “1”, the CPU 202A of the second information processing unit 202 obtains the original command A, which is associated information corresponding to the short command “1” and having a larger amount of information than the short command “1”, from the cache memory 202B of the second information processing unit 202.

In this process, then, as indicated by numeral 2H, the CPU 202A of the second information processing unit 202 executes the command A, which is the associated information corresponding to the short command “1”.

In this exemplary embodiment, accordingly, when transmitting a command to the second information processing unit 202, the first information processing unit 201 transmits a short command rather than the command itself.

In other words, in this exemplary embodiment, when, for example, a command expressed as “image enlargement or reduction (width: 120%, height: 120%, image data (1))” is to be transmitted as the command A, information having a smaller amount of information than the command and capable of identifying the command is transmitted if the number of transmissions of the command is greater than a predetermined number. Accordingly, the amount of communication for transmitting the information is reduced compared to that for transmitting the command A itself.

The first information processing unit 201 may transmit partial information included in the command to the second information processing unit 202. Whereas in the example described above, the command expressed as “image enlargement or reduction (width: 120%, height: 120%, image data (1))” is transmitted, for example, information indicating only “image enlargement or reduction” may be transmitted.

If the previous transmission history includes no command for “image enlargement or reduction”, the transmission of information indicating “image enlargement or reduction” allows the receiver to identify the command expressed as “image enlargement or reduction (width: 120%, height: 120%, image data (1))” on the basis of the information.

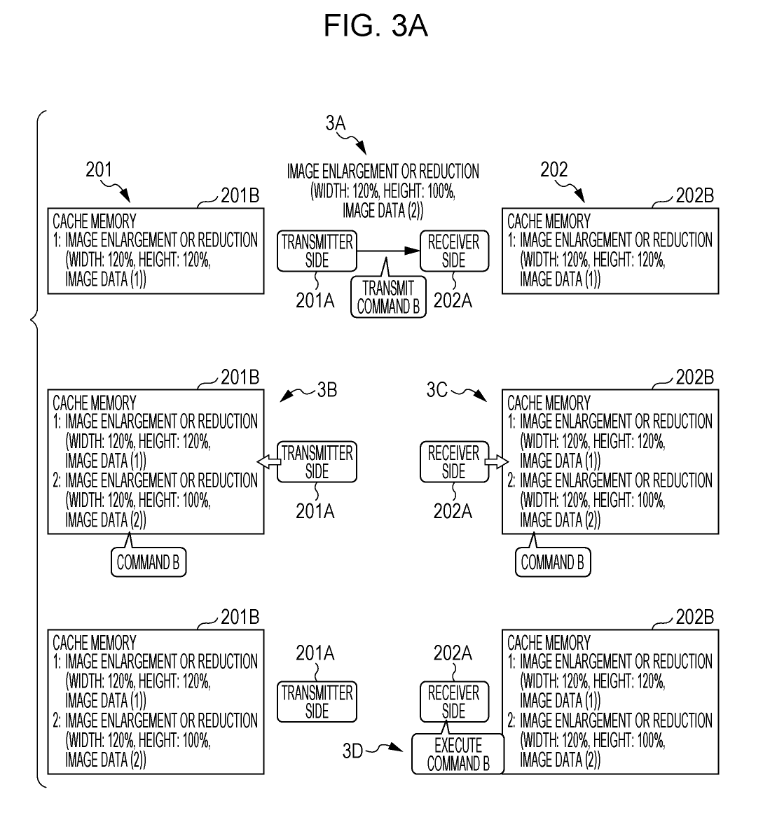

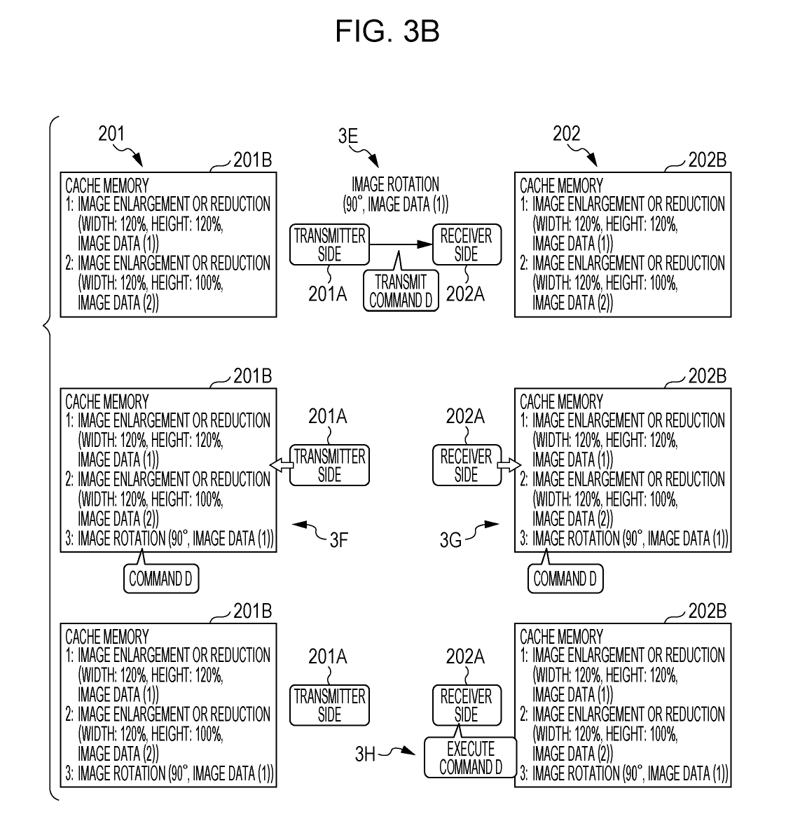

The processing is still described with reference to FIGS. 3A and 3B.

FIG. 3A illustrates a process for transmitting the command B from the first information processing unit 201 to the second information processing unit 202 when the command A and the short command “1” are in the cache memory 201B of the first information processing unit 201.

More specifically, a process for transmitting the command B to the second information processing unit 202 more than a predetermined number of times is illustrated.

In this case, before the number of transmissions of the command B is greater than the predetermined number, as indicated by numeral 3A, the command B itself is transmitted from the first information processing unit 201 to the second information processing unit 202.

When the number of transmissions of the command B is greater than the predetermined number, short command “2” is transmitted from the first information processing unit 201 to the second information processing unit 202.

When the number of transmissions of the command B is greater than the predetermined number, as indicated by numerals 3B and 3C, the command B and the short command “2” corresponding to the command B are stored in both the cache memory 201B of the first information processing unit 201 and the cache memory 202B of the second information processing unit 202.

In the example process illustrated in FIG. 3A, furthermore, when the second information processing unit 202 receives the command B, as indicated by numeral 3D, the second information processing unit 202 executes the command B.

FIG. 3B illustrates that the command D is transmitted to the second information processing unit 202 in the state illustrated in FIG. 3A.

In other words, FIG. 3B exemplarily illustrates the transmission of the command D to the second information processing unit 202 when the command A, the short command “1”, the command B, and the short command “2” are stored in the cache memory 201B of the first information processing unit 201. More specifically, the transmission of the command D to the second information processing unit 202 more than a predetermined number of times is illustrated.

In this case, as described above, before the number of transmissions of the command D is greater than the predetermined number, as indicated by numeral 3E, the command D itself is transmitted from the first information processing unit 201 to the second information processing unit 202.

When the number of transmissions of the command D is greater than the predetermined number, short command “3” is transmitted. Further, as indicated by numerals 3F and 3G, the command D and the short command “3” are stored in both the cache memory 201B of the first information processing unit 201 and the cache memory 202B of the second information processing unit 202.

Furthermore, as indicated by numeral 3H, the second information processing unit 202 executes the command D.

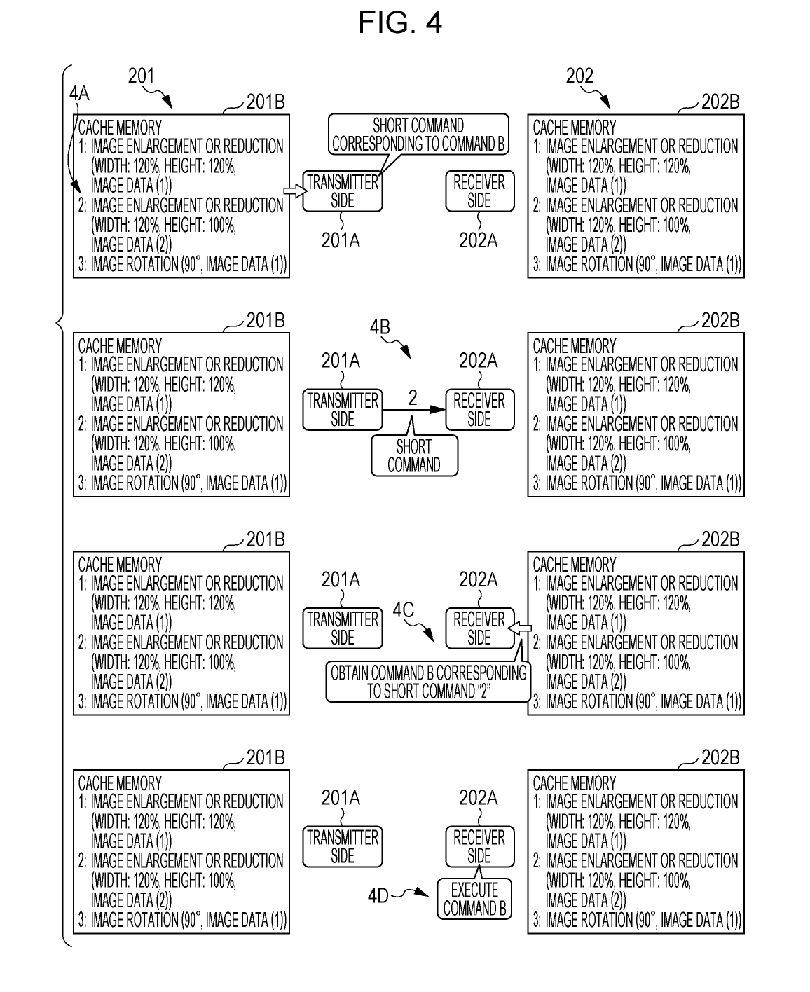

The processing is still described with reference to FIG. 4.

FIG. 4 illustrates that the command B is further transmitted from the first information processing unit 201 to the second information processing unit 202.

In the process illustrated in FIG. 4, when the command B is to be transmitted, as indicated by numeral 4A, the short command “2” has already been stored in the cache memory 201B of the first information processing unit 201.

Thus, in this process, as indicated by numeral 4B, the short command “2”, rather than the command B itself, which has a smaller amount of information than the command B, is transmitted.

When the second information processing unit 202 serving as the receiver-side information processing unit receives the short command “2”, as indicated by numeral 4C, the CPU 202A of the second information processing unit 202 obtains the command B corresponding to the short command “2” from the cache memory 202B of the second information processing unit 202.

Then, as indicated by numeral 4D, the CPU 202A of the second information processing unit 202 executes the obtained command B.

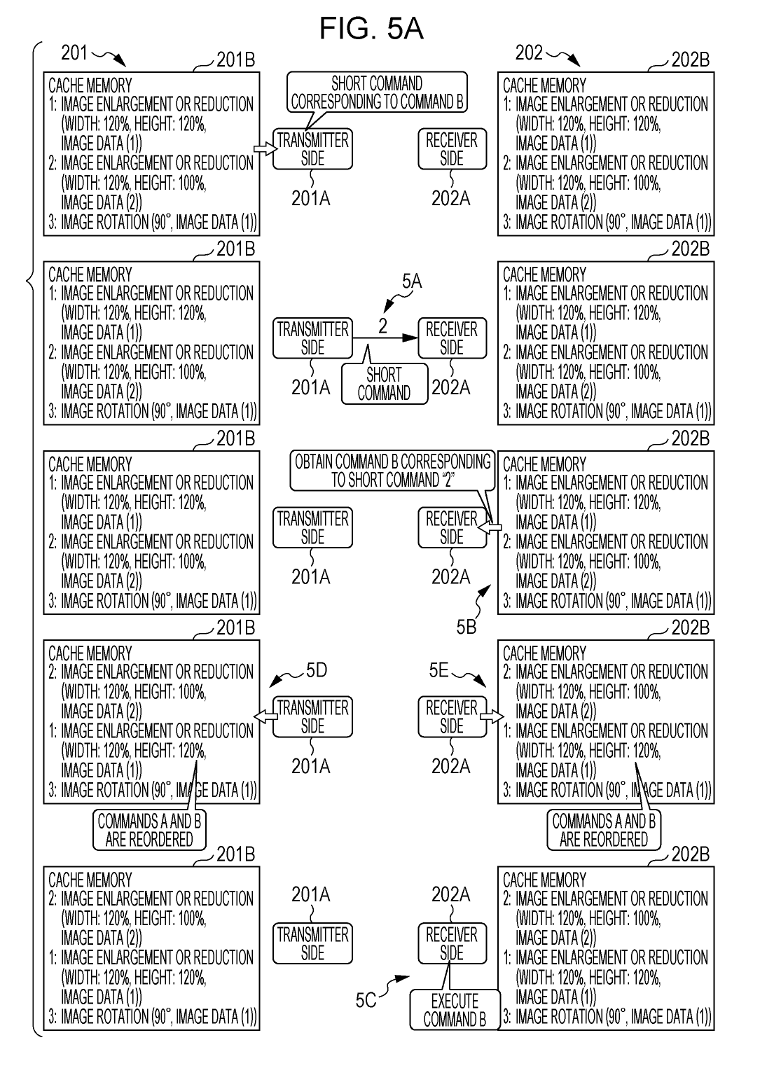

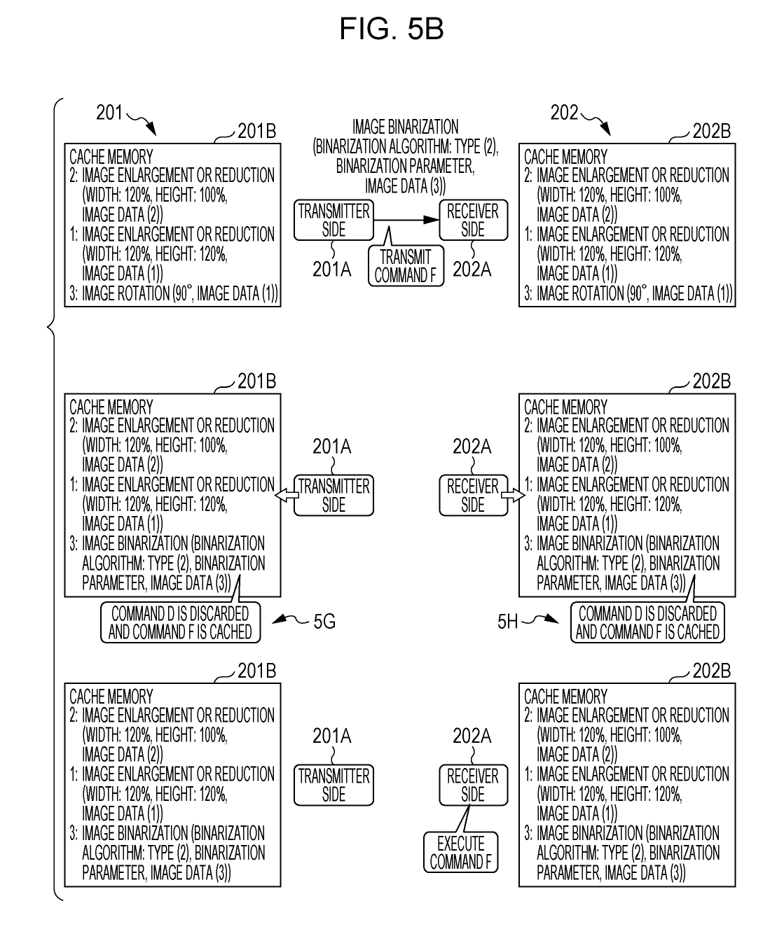

FIG. 5A illustrates that the command B is further transmitted in the state illustrated in FIG. 4. Also in this case, as described above, as indicated by numeral 5A, the short command “2”, rather than the command B, which has a smaller amount of information than the command B, is transmitted.

Then, in the second information processing unit 202 serving as the receiver-side information processing unit, as described above, as indicated by numeral 5B, the command B corresponding to the short command “2” is obtained from the cache memory 202B of the second information processing unit 202. Then, as indicated by numeral 5C, the CPU 202A of the second information processing unit 202 executes the obtained command B.

In FIG. 5A, by way of example, the command B is used more frequently (is transmitted and received more frequently) than the command A. In this case, as indicated by numeral 5D, the order of the cached commands in the cache memory 201B of the first information processing unit 201 is changed.

Specifically, the command B is placed in a higher rank than the command A.

Also in the second information processing unit 202, as indicated by numeral 5E, the command B is placed in a higher rank than the command A.

FIG. 5B illustrates an example of a process performed after the state illustrated in FIG. 5A.

More specifically, FIG. 5B exemplarily illustrates that when the commands B, A, and D are cached in the first information processing unit 201 and the second information processing unit 202, the command F is used more frequently than the command D (the number of transmissions of the command F is greater than the number of transmissions of the command D) and the order of the cached commands is changed.

Specifically, in the illustrated example, the command F is transmitted from the first information processing unit 201 to the second information processing unit 202 more than a predetermined number of times and the number of transmissions of the command F is greater than the number of transmissions of the command D.

In this case, as indicated by numerals 5G and 5H, in both the cache memory 201B of the first information processing unit 201 and the cache memory 202B of the second information processing unit 202, the command D is discarded (or deleted) and the command F is stored.

In this exemplary embodiment, each piece of transmission information (each command) to be transmitted from the first information processing unit 201 to the second information processing unit 202 is assigned a rank based on the number of transmissions of the piece of transmission information (command) to be transmitted from the first information processing unit 201 to the second information processing unit 202. That is, transmission information (command) transmitted more times is assigned a higher rank.

In this exemplary embodiment, furthermore, although not described above, when transmission information (command) to be transmitted from the first information processing unit 201 to the second information processing unit 202 is not stored in the cache memory 201B of the first information processing unit 201 and has a rank higher than a predetermined rank, the process for storing the transmission information in the cache memory 201B is performed.

In this exemplary embodiment, furthermore, when the rank of transmission information stored in the cache memory 201B of the first information processing unit 201 is lower than the predetermined rank, the transmission information is deleted from the cache memory 201B.

The second information processing unit 202 also performs similar processing. Specifically, in the second information processing unit 202, each piece of transmission information (each command) transmitted from the first information processing unit 201, when received by the second information processing unit 202, is assigned a rank based on the number of receptions of the piece of transmission information (command) transmitted from the first information processing unit 201. When transmission information transmitted from the first information processing unit 201 has a rank higher than a predetermined rank, the second information processing unit 202 stores the transmission information in the cache memory 202B.

In this exemplary embodiment, as described above, the first information processing unit 201 and the second information processing unit 202 transmit and receive information using the same algorithm. Thus, the predetermined rank on which whether to store information in each cache memory is based employs the same ranking standard, such as “higher than or equal to the third rank”, for both the first information processing unit 201 and the second information processing unit 202.

It is conceivable that the first information processing unit 201 and the second information processing unit 202 store information (command) in the cache memory 201B and the cache memory 202B, respectively, each time the information is transmitted and received. In this case, however, less frequently transmitted (less frequently received) information may also be stored in each cache memory, which may become the shortage of the capacity of the cache memory.

It is also conceivable that, as described above, information transmitted and received more than a predetermined number of times is stored in each cache memory. In this case, however, depending on the predetermined number of times, less frequently transmitted and received information may be more likely to be stored in each cache memory or may be, conversely, be less likely to be stored in each cache memory.

Specifically, for example, if the predetermined number of times is a small value such as “2”, less frequently transmitted and received information is more likely to be stored in each cache memory. For example, if the predetermined number of times is a large value such as “50”, less frequently information is less likely to be stored in each cache memory. In contrast, in the configuration described above in which information assigned a higher rank than a predetermined rank is stored, more frequently transmitted and received information is more likely to be stored in each cache memory whereas less frequently transmitted and received information is less likely to be stored in each cache memory.

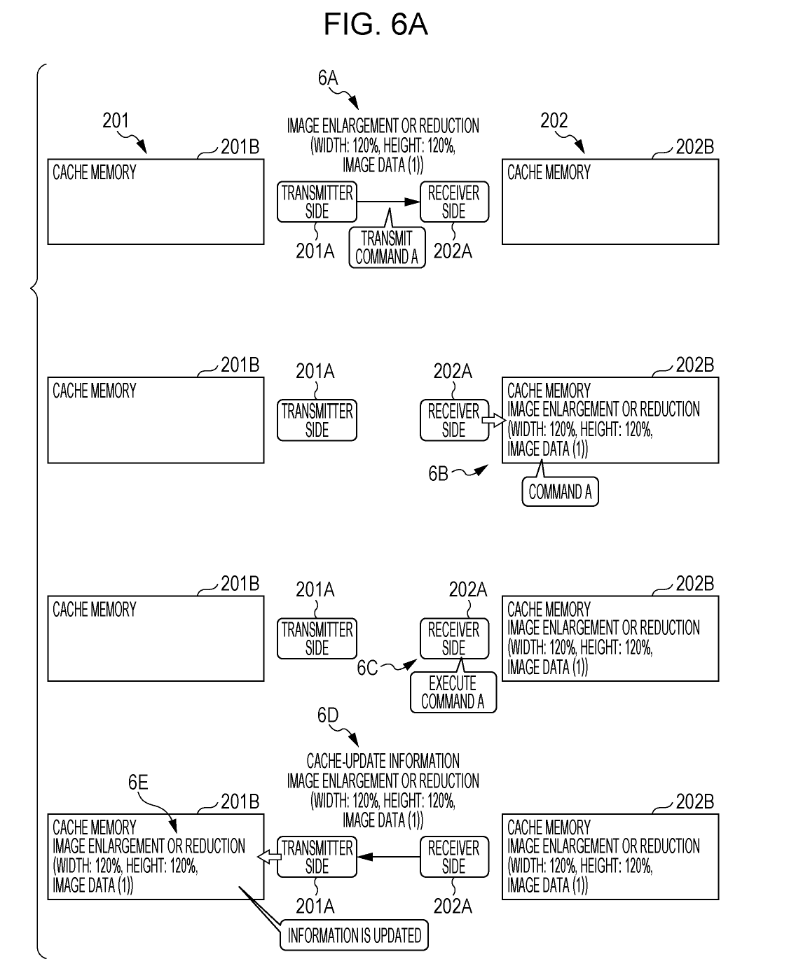

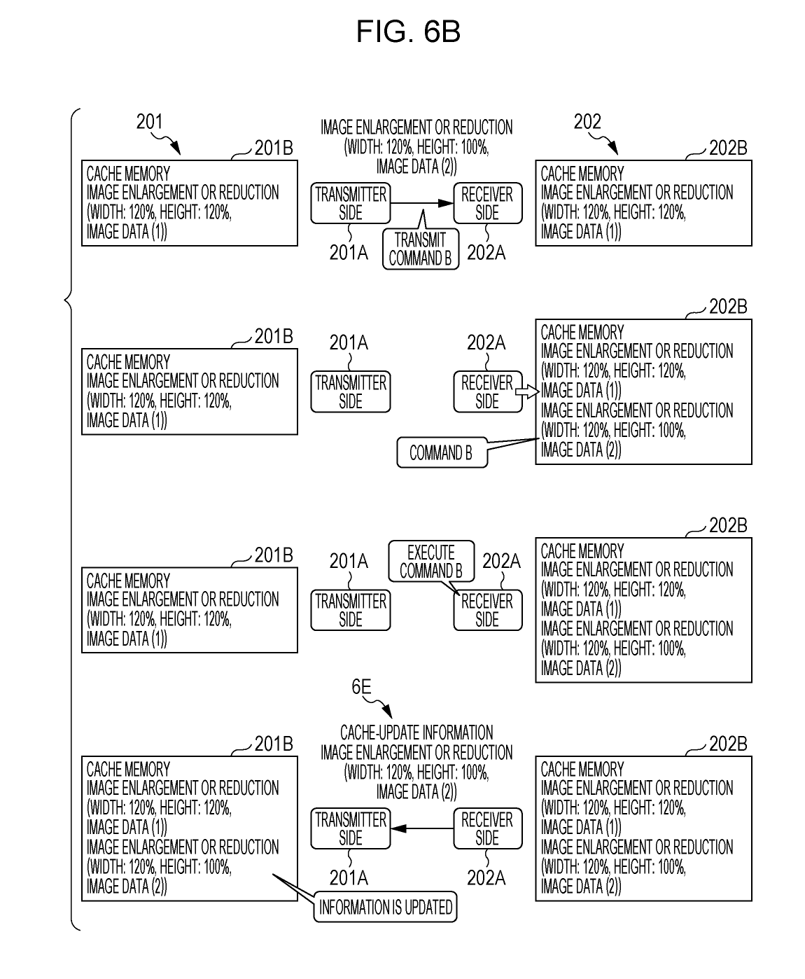

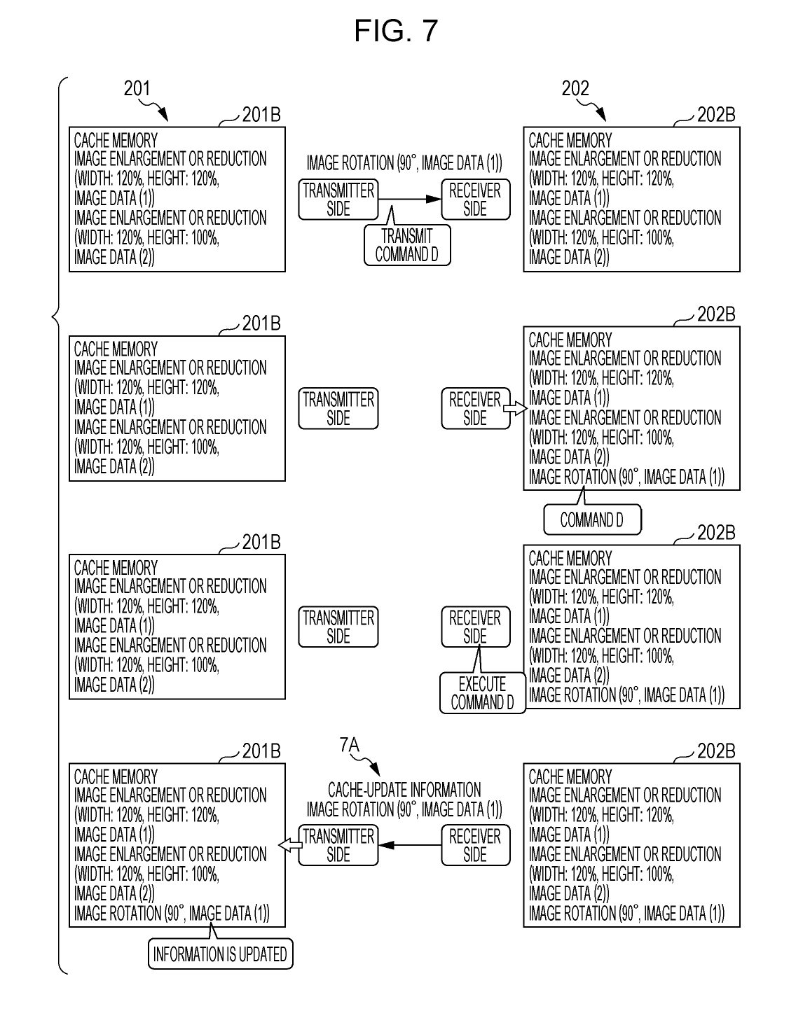

FIGS. 6A, 6B, and 7 illustrate processing according to a comparative example.

In the comparative example, commands A to F that are similar to those according to this exemplary embodiment described above are used.

In the illustrated example process, as described above and as indicated by numerals 6A and 6B in FIG. 6A, the command A is transmitted from the first information processing unit 201 to the second information processing unit 202, and the command A is stored in the cache memory 202B of the second information processing unit 202. Then, as indicated by numeral 6C, the second information processing unit 202 executes the command A.

In the example process, thereafter, as indicated by numeral 6D, cache-update information is transmitted from the second information processing unit 202 to the first information processing unit 201. Specifically, information on the command A, which is executed by the second information processing unit 202 and is stored in the cache memory 202B, is transmitted from the second information processing unit 202 to the first information processing unit 201.

Then, as indicated by numeral 6E, the information on the command A is stored in the cache memory 201B of the first information processing unit 201.

In the comparative example, in this way, cache-update information is transmitted from the second information processing unit 202 to the first information processing unit 201.

In this case, the amount of communication between the first information processing unit 201 and the second information processing unit 202 is larger than that in the exemplary embodiment described above in which no cache-update information is transmitted.

FIG. 6B illustrates that the command B is transmitted to the second information processing unit 202 multiple times in the state illustrated in FIG. 6A.

In the process according to this exemplary embodiment described above, when a command is transmitted more than a predetermined number of times, a short command is transmitted thereafter.

In this process according to the comparative example, in contrast, the command B itself is transmitted to the second information processing unit 202 regardless of the number of transmissions of the command B to the second information processing unit 202. In this case, the amount of communication is larger than that in the process according to this exemplary embodiment.

Also in this process, as in the process illustrated in FIG. 6A, upon storing the command B in the cache memory 202B of the second information processing unit 202, as indicated by numeral 6E, cache-update information is transmitted from the second information processing unit 202 to the first information processing unit 201.

In this case, the amount of communication between the first information processing unit 201 and the second information processing unit 202 is larger than that in the exemplary embodiment described above in which no cache-update information is transmitted.

FIG. 7 illustrates that the command D is transmitted to the second information processing unit 202 multiple times in the state illustrated in FIG. 6B.

Also in this case, the command D itself is transmitted to the second information processing unit 202 regardless of the number of transmissions of the command D to the second information processing unit 202.

Then, as described above, upon storing the command D in the cache memory 202B of the second information processing unit 202, as indicated by numeral 7A, cache-update information is transmitted from the second information processing unit 202 to the first information processing unit 201.

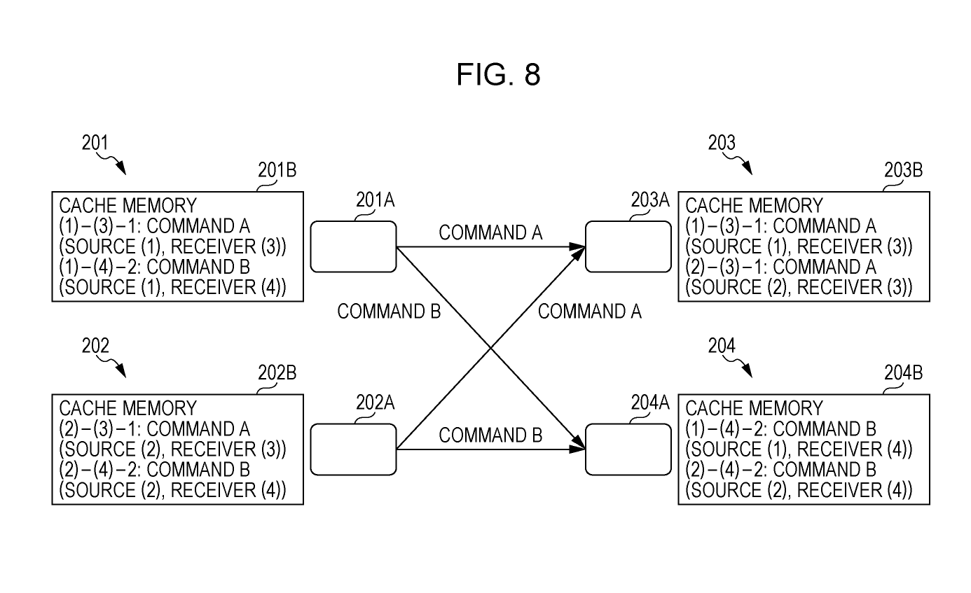

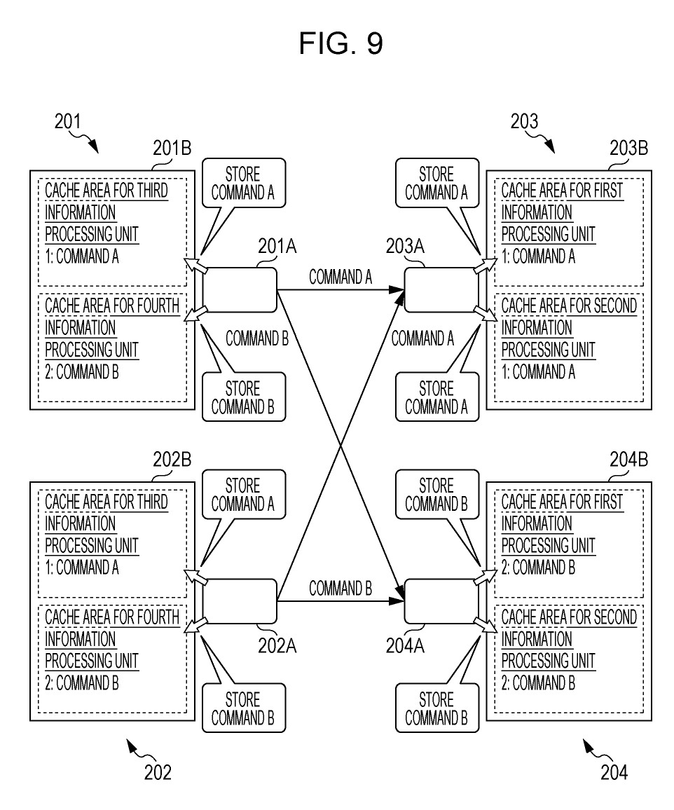

FIGS. 8 and 9 illustrate other example configurations of the transmitting and receiving system.

As illustrated in FIG. 8, the transmitting and receiving system includes the first information processing unit 201, the second information processing unit 202, a third information processing unit 203, and a fourth information processing unit 204. In the transmitting and receiving system, commands are transmitted from the first information processing unit 201 and the second information processing unit 202 to the third information processing unit 203 and the fourth information processing unit 204, by way of example.

In the transmitting and receiving system, multiple transmitter-side information processing units and multiple receiver-side information processing units are used. In this case, it is difficult to maintain the identity between information in each of the transmitter-side information processing units and information in the associated one of the receiver-side information processing units (the identity between information stored in a cache on the transmitter side and information stored in a cache on the receiver side).

To address this difficulty, in the transmitting and receiving system illustrated in FIG. 8, an identifier is used to maintain the identity between pieces of information. In the transmitting and receiving system illustrated in FIG. 9, multiple cache tables are used to maintain the identity between pieces of information.

Specifically, in the example configuration illustrated in FIG. 8, when a command is to be transmitted, identification information identifying an information processing unit that transmits the command and identification information identifying an information processing unit that receives the command are also transmitted.

That is, in the example configuration illustrated in FIG. 8, when transmitting a command to a receiver-side information processing unit, a transmitter-side information processing unit transmits three pieces of information, namely, the command, transmitter-side identification information that identifies the transmitter-side information processing unit, and receiver-side identification information that identifies the receiver-side information processing unit.

Specifically, for example, when transmitting the command A to the third information processing unit 203, the first information processing unit 201 transmits the command A, transmitter-side identification information, namely, “source (1)”, and receiver-side identification information, namely, “receiver (3)”.

For example, when transmitting the command B to the fourth information processing unit 204, the first information processing unit 201 transmits the command B, transmitter-side identification information, namely, “source (1)”, and receiver-side identification information, namely, “receiver (4)”.

For example, when transmitting the command A to the third information processing unit 203, the second information processing unit 202 transmits the command A, transmitter-side identification information, namely, “source (2)”, and receiver-side identification information, namely, “receiver (3)”.

For example, when transmitting the command B to the fourth information processing unit 204, the second information processing unit 202 transmits the command B, transmitter-side identification information, namely, “source (2)”, and receiver-side identification information, namely, “receiver (4)”.

When information is to be stored in the cache memory 201B and the cache memory 202B of the first information processing unit 201 and the second information processing unit 202, which are transmitter-side information processing units, as described above, if the number of transmissions of a command is greater than a predetermined number or if the rank of the command is higher than a predetermined rank, three pieces of information, namely, the command, transmitter-side identification information, and receiver-side identification information, are stored.

Specifically, when information is to be stored in the cache memory 201B of the first information processing unit 201, if the number of transmissions of the command A to the third information processing unit 203 is greater than a predetermined number or if the rank of the command A is higher than a predetermined rank, the command A, transmitter-side identification information, namely, “source (1)”, and receiver-side identification information, namely, “receiver (3)”, are stored.

When information is to be stored in the cache memory 201B of the first information processing unit 201, if the number of transmissions of the command B to the fourth information processing unit 204 is greater than a predetermined number or if the rank of the command B is higher than a predetermined rank, the command B, transmitter-side identification information, namely, “source (1)”, and receiver-side identification information, namely, “receiver (4)”, are stored.

When information is to be stored in the cache memory 202B of the second information processing unit 202, if the number of transmissions of the command A to the third information processing unit 203 is greater than a predetermined number or if the rank of the command A is higher than a predetermined rank, the command A, transmitter-side identification information, namely, “source (2)”, and receiver-side identification information, namely, “receiver (3)”, are stored.

When information is to be stored in the cache memory 202B of the second information processing unit 202, if the number of transmissions of the command B to the fourth information processing unit 204 is greater than a predetermined number or if the rank of the command B is higher than a predetermined rank, the command B, transmitter-side identification information, namely, “source (2)”, and receiver-side identification information, namely, “receiver (4)”, are stored.

When information is to be stored in a cache memory 203B and a cache memory 204B of the third information processing unit 203 and the fourth information processing unit 204, which are receiver-side information processing units, if the number of receptions of a command is greater than a predetermined number or if the rank of the received command is higher than a predetermined rank, three pieces of information, namely, the command, transmitter-side identification information, and receiver-side identification information, are stored.

Specifically, when information is to be stored in the cache memory 203B of the third information processing unit 203, if the number of receptions of the command A from the first information processing unit 201 is greater than a predetermined number or if the rank of the command A is higher than a predetermined rank, the command A, transmitter-side identification information, namely, “source (1)”, and receiver-side identification information, namely, “receiver (3)”, are stored.

When information is to be stored in the cache memory 203B of the third information processing unit 203, if the number of receptions of the command A from the second information processing unit 202 is greater than a predetermined number or if the rank of the command A is higher than a predetermined rank, the command A, transmitter-side identification information, namely, “source (2)”, and receiver-side identification information, namely, “receiver (3)”, are stored.

When information is to be stored in the cache memory 204B of the fourth information processing unit 204, if the number of receptions of the command B from the first information processing unit 201 is greater than a predetermined number or if the rank of the command B is higher than a predetermined rank, the command B, transmitter-side identification information, namely, “source (1)”, and receiver-side identification information, namely, “receiver (4)”, are stored.

When information is to be stored in the cache memory 204B of the fourth information processing unit 204, if the number of receptions of the command B from the second information processing unit 202 is greater than a predetermined number or if the rank of the command B is higher than a predetermined rank, the command B, transmitter-side identification information, namely, “source (2)”, and receiver-side identification information, namely, “receiver (4)”, are stored.

As described above, when three pieces of information, namely, a command, transmitter-side identification information, and receiver-side identification information, are to be transmitted to a receiver-side information processing unit, a short command is transmitted if the number of transmissions of the three pieces of information is greater than a predetermined number or if the rank of the command is higher than a predetermined rank. In this case, the receiver-side information processing unit reads the command corresponding to the short command from the cache memory thereof and executes the read command.

Specifically, for example, if the number of transmissions of the command A to be transmitted from the first information processing unit 201 to the third information processing unit 203 is greater than a predetermined number or if the rank of the command A is higher than a predetermined rank, short command “(1)-(3)-1” is transmitted. The third information processing unit 203 reads the command A corresponding to the short command “(1)-(3)-1” from the cache memory thereof and executes the read command A.

For example, if the number of transmissions of the command B to be transmitted from the first information processing unit 201 to the fourth information processing unit 204 is greater than a predetermined number or if the rank of the command B is higher than a predetermined rank, short command “(1)-(4)-2” is transmitted. The fourth information processing unit 204 reads the command B corresponding to the short command “(1)-(4)-2” from the cache memory thereof and executes the read command B.

For example, if the number of transmissions of the command A to be transmitted from the second information processing unit 202 to the third information processing unit 203 is greater than a predetermined number or if the rank of the command A is higher than a predetermined rank, short command “(2)-(3)-1” is transmitted. The third information processing unit 203 reads the command A corresponding to the short command “(2)-(3)-1” from the cache memory thereof and executes the read command A.

For example, if the number of transmissions of the command B to be transmitted from the second information processing unit 202 to the fourth information processing unit 204 is greater than a predetermined number or if the rank of the command B is higher than a predetermined rank, short command “(2)-(4)-2” is transmitted. The fourth information processing unit 204 reads the command B corresponding to the short command “(2)-(4)-2” from the cache memory thereof and executes the read command B.

In a configuration in which a command is transmitted from any one of multiple information processing units to another one of the multiple information processing units, multiple commands having different destinations are stored in a cache memory of a single information processing unit from which the information is transmitted. In this case, multiple commands having different sources are also stored in a cache memory of a single information processing unit that receives the information.

In this case, it is difficult to maintain the identity between information stored in a cache memory of the source information processing unit and information stored in a cache memory of the destination information processing unit.

In contrast, as in this exemplary embodiment, transmitter-side identification information and receiver-side identification information are also stored together with each command in the cache memories, which allows the command to be associated with the transmitter-side identification information and the receiver-side identification information. In this case, the identity between information (command) stored in the cache memory of the transmitter-side information processing unit and information (command) stored in the cache memory of the receiver-side information processing unit is substantially maintained.

FIG. 9 illustrates the maintenance of the identity between pieces of information stored in cache memories using multiple cache tables.

In the example configuration illustrated in FIG. 9, as described above, four information processing units, namely, the first information processing unit 201 to the fourth information processing unit 204, are included. Each information processing unit has a cache area (cache table) for each partner information processing unit with which the information processing unit communicates.

In this example configuration, cache areas used to store information are switched in accordance with the communication partner.

Specifically, the cache memory 201B of the first information processing unit 201 has a cache area associated with the third information processing unit 203 and a cache area associated with the fourth information processing unit 204.

The command A and the short command “1” to be transmitted from the first information processing unit 201 to the third information processing unit 203 are stored in the area associated with the third information processing unit 203 in the cache memory 201B included in the first information processing unit 201.

The command B and the short command “2” to be transmitted from the first information processing unit 201 to the fourth information processing unit 204 are stored in the area associated with the fourth information processing unit 204 in the cache memory 201B included in the first information processing unit 201.

Also, the second information processing unit 202 has a cache area associated with the third information processing unit 203 and a cache area associated with the fourth information processing unit 204.

The command A and the short command “1” to be transmitted from the second information processing unit 202 to the third information processing unit 203 are stored in the cache area associated with the third information processing unit 203 in the cache memory 202B included in the second information processing unit 202.

The command B and the short command “2” to be transmitted from the second information processing unit 202 to the fourth information processing unit 204 are stored in the cache area associated with the fourth information processing unit 204 in the cache memory 202B included in the second information processing unit 202.

Also, the third information processing unit 203 has a cache area associated with the first information processing unit 201 and a cache area associated with the second information processing unit 202.

The command A and the short command “1” transmitted from the first information processing unit 201 to the third information processing unit 203 are stored in the area associated with the first information processing unit 201 in the cache memory 203B included in the third information processing unit 203.

The command A and the short command “1” transmitted from the second information processing unit 202 to the third information processing unit 203 are stored in the area associated with the second information processing unit 202 in the cache memory 203B included in the third information processing unit 203.

Also, the fourth information processing unit 204 has a cache area associated with the first information processing unit 201 and a cache area associated with the second information processing unit 202.

The command B and the short command “2” transmitted from the first information processing unit 201 to the fourth information processing unit 204 are stored in the cache area associated with the first information processing unit 201 in the cache memory 204B included in the fourth information processing unit 204.

The command B and the short command “2” transmitted from the second information processing unit 202 to the fourth information processing unit 204 are stored in the cache area associated with the second information processing unit 202 in the cache memory 204B included in the fourth information processing unit 204.

Also in the example configuration illustrated in FIG. 9, each command is substantially associated with the destination to which the information is transmitted and the source from which the information is transmitted. The association of each command with the source and the destination allows the identity between information (command) stored in a cache memory of a transmitter-side information processing unit and information (command) stored in a cache memory of a receiver-side information processing unit to be maintained.

### Other Embodiments

The foregoing description provides the transmission and reception of information between multiple information processing units included in the single image forming apparatus 10, by way of example but not limitation. The processes described above may be applied to the transmission and reception of information between two different apparatuses that are separate from each other.

In addition, in the foregoing description, transmission information to be transmitted from one information processing unit to another information processing unit is a command, by way of example but not limitation. The transmission information is not limited to a command (an instruction) and may be data other than a command.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transmitting and receiving system comprising:
a first information processing apparatus including a first cache memory; and
a second information processing apparatus including a second cache memory and configured to transmit and receive information to and from the first information processing apparatus,
wherein when transmission information to be transmitted from the first information processing apparatus to the second information processing apparatus is stored in the first cache memory of the first information processing apparatus, the first information processing apparatus transmits partial information that is included in the stored transmission information to the second information processing apparatus or transmits identification information that identifies the transmission information to the second information processing apparatus.

2. The transmitting and receiving system according to claim 1, wherein when transmission information to be transmitted from the first information processing apparatus to the second information processing apparatus is not stored in the first cache memory of the first information processing apparatus, the first information processing apparatus stores the transmission information in the first cache memory.

3. The transmitting and receiving system according to claim 2, wherein when the transmission information is not stored in the first cache memory of the first information processing apparatus and when the number of transmissions of the transmission information to the second information processing apparatus is greater than a predetermined number, the first information processing apparatus stores the transmission information in the first cache memory.

4. The transmitting and receiving system according to claim 2, wherein each piece of transmission information to be transmitted from the first information processing apparatus to the second information processing apparatus is assigned a rank based on the number of transmissions of the piece of transmission information to be transmitted from the first information processing apparatus to the second information processing apparatus, and
wherein when a piece of transmission information to be transmitted from the first information processing apparatus to the second information processing apparatus has a rank higher than a predetermined rank, the first information processing apparatus stores the piece of transmission information in the first cache memory.

5. The transmitting and receiving system according to claim 4, wherein when a piece of transmission information stored in the first cache memory of the first information processing apparatus has a rank lower than the predetermined rank, the first information processing apparatus deletes the piece of transmission information from the first cache memory.

6. The transmitting and receiving system according to claim 1, wherein the second information processing apparatus stores transmission information transmitted thereto from the first information processing apparatus in the second cache memory.

7. The transmitting and receiving system according to claim 6, wherein the second information processing apparatus stores transmission information transmitted thereto from the first information processing apparatus in the second cache memory when the number of receptions of the transmission information is greater than a predetermined number.

8. The transmitting and receiving system according to claim 6, wherein the second information processing apparatus assigns a rank to each piece of transmission information transmitted thereto from the first information processing apparatus, which is received by the second information processing apparatus, based on the number of receptions of the piece of transmission information transmitted thereto from the first information processing apparatus, and
wherein the second information processing apparatus stores a piece of transmission information transmitted thereto from the first information processing apparatus in the second cache memory when the piece of transmission information has a rank higher than a predetermined rank.

9. The transmitting and receiving system according to claim 1, wherein in response to receipt of the partial information or the identification information, the second information processing apparatus obtains associated information corresponding to the received information from the second cache memory, the associated information having a larger amount of information than the received information.

10. The transmitting and receiving system according to claim 1, wherein when the first information processing apparatus is to transmit transmission information to the second information processing apparatus, the first information processing apparatus stores the transmission information in the first cache memory if the transmission information is not stored in the first cache memory of the first information processing apparatus and if the number of transmissions of the transmission information to the second information processing apparatus is greater than a predetermined number, and
wherein the second information processing apparatus stores the transmission information transmitted thereto from the first information processing apparatus in the second cache memory if the number of receptions of the transmission information is greater than the predetermined number.

11. The transmitting and receiving system according to claim 1, wherein the first information processing apparatus assigns a rank to each piece of transmission information to be transmitted from the first information processing apparatus to the second information processing apparatus based on the number of transmissions of the piece of transmission information to be transmitted from the first information processing apparatus to the second information processing apparatus,
wherein the second information processing apparatus assigns a rank to each piece of transmission information transmitted thereto from the first information processing apparatus, which is received by the second information processing apparatus, based on the number of receptions of the piece of transmission information transmitted thereto from the first information processing apparatus,
wherein the first information processing apparatus stores a piece of transmission information to be transmitted from the first information processing apparatus to the second information processing apparatus in the first cache memory when the piece of transmission information has a rank higher than a predetermined rank, and
wherein the second information processing apparatus stores a piece of transmission information transmitted thereto from the first information processing in the second cache memory when the piece of transmission information apparatus has a rank higher than the predetermined rank.

12. The transmitting and receiving system according to claim 1, wherein when the first information processing apparatus transmits transmission information to the second information processing apparatus, the first information processing apparatus further transmits information that identifies the first information processing apparatus and information that identifies the second information processing apparatus.

13. The transmitting and receiving system according to claim 2, wherein the first information processing apparatus stores transmission information to be transmitted to the second information processing apparatus in the first cache memory such that the transmission information is included in an area associated with the second information processing apparatus within the first cache memory.

14. The transmitting and receiving system according to claim 6, wherein the second information processing apparatus stores transmission information transmitted thereto from the first information processing apparatus in the second cache memory such that the transmission information is included in an area associated with the first information processing apparatus within the second cache memory.

15. A transmitting and receiving system comprising:
a first information processing apparatus; and
a second information processing apparatus,
the first information processing apparatus and the second information processing apparatus transmitting and receiving information to and from each other and each including a cache memory that stores the information,
wherein when the first information processing apparatus is to transmit information to the second information processing apparatus, the first information processing apparatus stores the information in the cache memory of the first information processing apparatus.

16. The transmitting and receiving system according to claim 15, wherein when the number of transmissions of information to be transmitted to the second information processing apparatus is greater than a predetermined number, the first information processing apparatus stores the information in the cache memory of the first information processing apparatus.

17. The transmitting and receiving system according to claim 15, wherein the first information processing apparatus assigns a rank to each piece of information to be transmitted to the second information processing apparatus based on the number of transmissions of the piece of information to be transmitted to the second information processing apparatus, and
wherein when a piece of information to be transmitted to the second information processing apparatus has a rank higher than a predetermined rank, the first information processing apparatus stores the piece of information in the cache memory of the first information processing apparatus.

18. The transmitting and receiving system according to claim 15, wherein the second information processing apparatus stores information transmitted thereto from the first information processing apparatus in the cache memory of the second information processing apparatus when the number of receptions of the information is greater than a predetermined number.

19. The transmitting and receiving system according to claim 15, wherein the second information processing apparatus assigns a rank to each piece of information transmitted thereto from the first information processing apparatus based on the number of receptions of the piece of information transmitted thereto from the first information processing apparatus, and
wherein the second information processing apparatus stores a piece of information transmitted thereto from the first information processing apparatus in the cache memory of the second information processing apparatus when the piece of information has a rank higher than a predetermined rank.

20. An information processing apparatus comprising:
a cache memory that stores information; and
a transmitter that transmits information,
wherein when information to be transmitted is stored in the cache memory, the transmitter transmits partial information that is included in the information or transmits identification information that identifies the information.
